(19) United States
(12) Patent Application Publication
(10) Pub. No.: US 2009/0315530 A1
(43) Pub. Date: Dec. 24, 2009

(54) PULSE CONTROLLED SOFT START SCHEME FOR BUCK CONVERTER

(76) Inventor: SHAILENDRA KUMAR BARANWAL, Bangalore (IN)

Correspondence Address: Wade James Brady III;Texas Instruments Incorporated, M/S 3999, P.O. Box 655474, Dallas, TX, 75265, US

(21) Appl. No.: 12/141,085

(22) Filed: Jun. 18, 2008

(51) Int. Cl. G05F 1/56

(52) U.S. Cl. 323/288

(57) ABSTRACT

A pulse controlled soft start scheme for a buck converter using a low value of on-chip capacitor is disclosed. In one embodiment, a system for generating a ramped reference voltage to soft start a buck converter, includes a current source coupled to a positive power supply, a capacitor coupled to a ground, a pass transistor device coupled to the current source and the capacitor in series, and a control pulse generator for generating a control pulse forwarded to the pass transistor device. The ramped reference voltage forwarded to the buck converter includes a voltage across the capacitor. The control pulse regulates a flow of a current from the current source to the capacitor via the pass transistor device for generating the ramped reference voltage.

### FIELD OF TECHNOLOGY

Embodiments of the present invention relate to the field of electronics. More particularly, embodiments of the present invention relate to a buck converter.

### BACKGROUND

A buck converter is a step-down DC to DC converter. It uses two switches, an inductor, and a capacitor. The two switches are used to alternate between connecting the inductor to a source voltage to store energy in the inductor and discharging the inductor into the load coupled across the capacitor.

One exemplary use of the buck converter is to supply a step-down voltage to a system on chip. In order to generate a constant level of the step-down voltage, output voltage of the buck converter is compared with its reference voltage, and the switches are controlled based on the comparison. If the output voltage is lower than the reference voltage, then the switches are configured to charge the inductor. If the output voltage is higher than the reference voltage, then the switches are adjusted to stop the charging of the inductor. However, even if the current to the inductor is cutoff, the capacitor is still being charged due to tank behavior of the inductor and the capacitor, thus raising the output voltage beyond the reference voltage. This overshoot may cause damage in the two switches, inductor, and/or the capacitor of the buck converter.

In order to correct the problem, a soft start scheme is implemented in the buck converter. According to the soft start scheme, the reference voltage (e.g., ramped reference voltage) is slowly varied to avoid the problem due to the excess current flowing through the circuit components. The soft start scheme generates the ramped reference voltage by charging a capacitor by a small value of constant current. However, the soft start scheme requires the capacitor to have a size too big to be on the system on chip. For example, assuming the charging current is 1 uA, the required capacitor size for a typical slope of the ramped reference voltage of 0.5 V/ms would be 2 nF, which is too big to fit on the system on chip. Consequently, an additional off chip capacitor may be implemented for the soft start scheme. However, the additional off chip capacitor may eat up more real estate in the design of buck converter, and may increase its cost.

### SUMMARY

A pulse controlled soft start scheme for a buck converter is disclosed. In one aspect, a system for generating a ramped reference voltage to soft start a buck converter includes a current source coupled to a positive power supply, a capacitor coupled to a ground, and a switch coupled to the current source and the capacitor in series. The ramped reference voltage is a voltage across the capacitor. The switch is regulated by a control pulse to direct a flow of a current from the current source for generating a pulsed current that is forwarded to the capacitor.

In another aspect, a system for generating a ramped reference voltage to soft start a buck converter includes a current source coupled to a positive power supply, a capacitor coupled to a ground, a pass transistor device coupled to the current source and the capacitor in series, and a control pulse generator for generating a control pulse that is forwarded to the pass transistor device. The ramped reference voltage forwarded to the buck converter includes a voltage across the capacitor. The control pulse controls the flow of a current from the current source to the capacitor via the pass transistor device for generating the ramped reference voltage.

Further, the control pulse generator includes a delay element which includes a first resistor and a first capacitor for processing an input signal, a Schmitt trigger coupled to the delay element for forwarding an output signal of the delay element, an inverter coupled to the Schmitt trigger for inverting the output signal, and an OR logic gate coupled to the inverter and to a node of the input signal for generating the control pulse by processing the output signal and the input signal.

In yet another aspect, a buck converter on a system on chip includes a first switch coupled to a voltage source, an inductor coupled to the first switch, a capacitor coupled to the inductor and to a ground in series, a second switch coupled to the inductor and to the capacitor, a pulse width modulation (PWM) controller for regulating the first switch and the second switch by comparing an output voltage measured across the capacitor and a ramped reference voltage, and a soft start circuit for forwarding the ramped reference voltage.

The soft start circuit further includes a current source coupled to a positive power supply, a first capacitor coupled to the ground, and a third switch coupled to the current source and the first capacitor in series. The third switch is regulated by a control pulse to direct a flow of a current from the current source for generating a pulsed current forwarded to the first capacitor. In addition, the control pulse is generated by a control pulse generator.

The systems and apparatuses disclosed herein may be implemented in any means for achieving various aspects. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a schematic diagram of an exemplary buck converter with a soft start circuit, according to one embodiment.

FIG. 2 is a schematic diagram for an exemplary system for generating a ramped reference voltage to soft start a buck converter, according to one embodiment.

FIG. 3A is a schematic diagram for an exemplary control pulse generator for regulating the switch of the system which generates the ramped reference voltage in FIG. 2, according to one embodiment.

FIG. 3B is an exemplary view illustrating an exemplary input signal supplied to the control pulse generator and an exemplary control pulse generated by the control pulse generator of FIG. 3A, according to one embodiment.

FIG. 4A is a schematic diagram for another exemplary system for generating a ramped reference voltage to soft start a buck converter, according to one embodiment.

FIG. 4B illustrates an exemplary view of the ramped reference voltage of FIG. 4A, according to one embodiment.

FIG. 4C illustrates an exploded view of the ramped reference voltage of FIG. 4B, according to one embodiment.

Other features of the present embodiments will be apparent from the accompanying drawings and from the detailed description that follows.

### DETAILED DESCRIPTION

A pulse controlled soft start scheme for a buck converter is disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

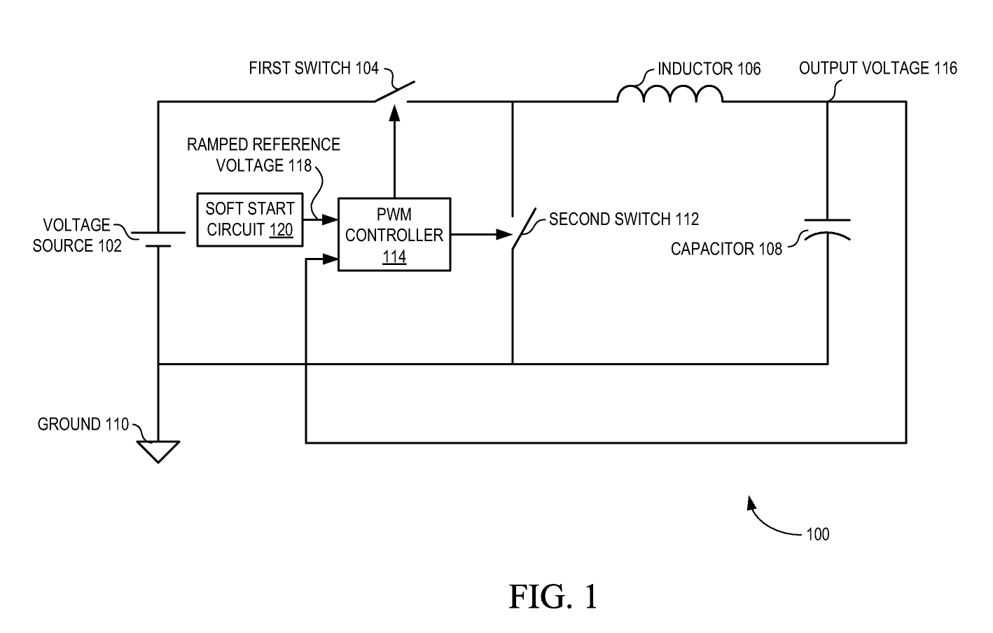

FIG. 1 is a schematic diagram of an exemplary buck converter 100 with a soft start circuit 120, according to one embodiment. Particularly, the buck converter 100 on a system on chip includes a first switch 104 coupled to a voltage source 102, an inductor 106 coupled to the first switch 104, and a capacitor 108 coupled to the inductor 106 and to a ground 110 in series. Further as shown in FIG. 1, the buck converter 100 includes a second switch 112 coupled to the inductor 106 and to the capacitor 108. The buck converter 100 also includes a pulse width modulation (PWM) controller 114 for regulating the first switch 104 and the second switch 112, and a soft start circuit 120 for forwarding a ramped reference voltage 118.

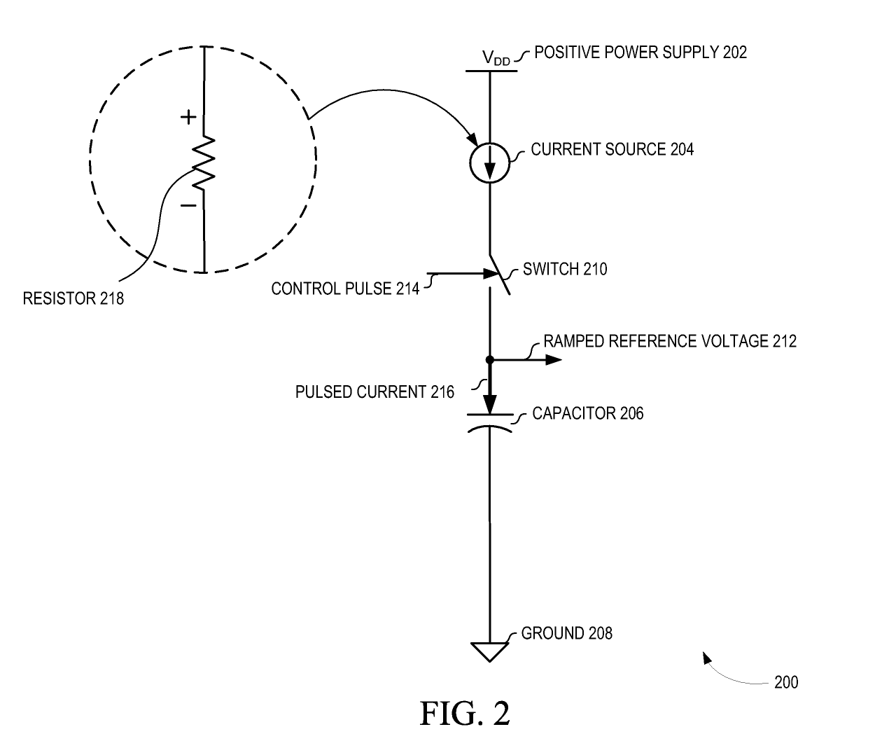

It is appreciated that the PWM controller 114 regulates the first switch 104 and the second switch 112 by comparing an output voltage 116 measured across the capacitor 108 and the ramped reference voltage 118. In one embodiment, as will be illustrated in FIG. 2 through FIG. 4C, the soft start circuit 120 for forwarding the ramped reference voltage includes a current source (e.g., a current source 204 of FIG. 2) coupled to a positive power supply V_{DD} (e.g., a positive power supply 202 of FIG. 2), a first capacitor (a capacitor 206 of FIG. 2) coupled to a ground (e.g., a ground 208 of FIG. 2), and a third switch (e.g., a switch 210 of FIG. 2) coupled to a current source (e.g., a current source 204) and a first capacitor (e.g., a first capacitor 206) in series.

In one example embodiment, the ramped reference voltage (e.g., the ramped reference voltage 118 of FIG. 1 or the ramped reference voltage 212 of FIG. 2) is a voltage across the capacitor. In one exemplary implementation, the third switch is regulated by a control pulse (e.g., a control pulse 214 of FIG. 2) to direct a flow of a current from the current source in order to generate a pulsed current (e.g., a pulsed current 216 of FIG. 2) forwarded to the capacitor 206.

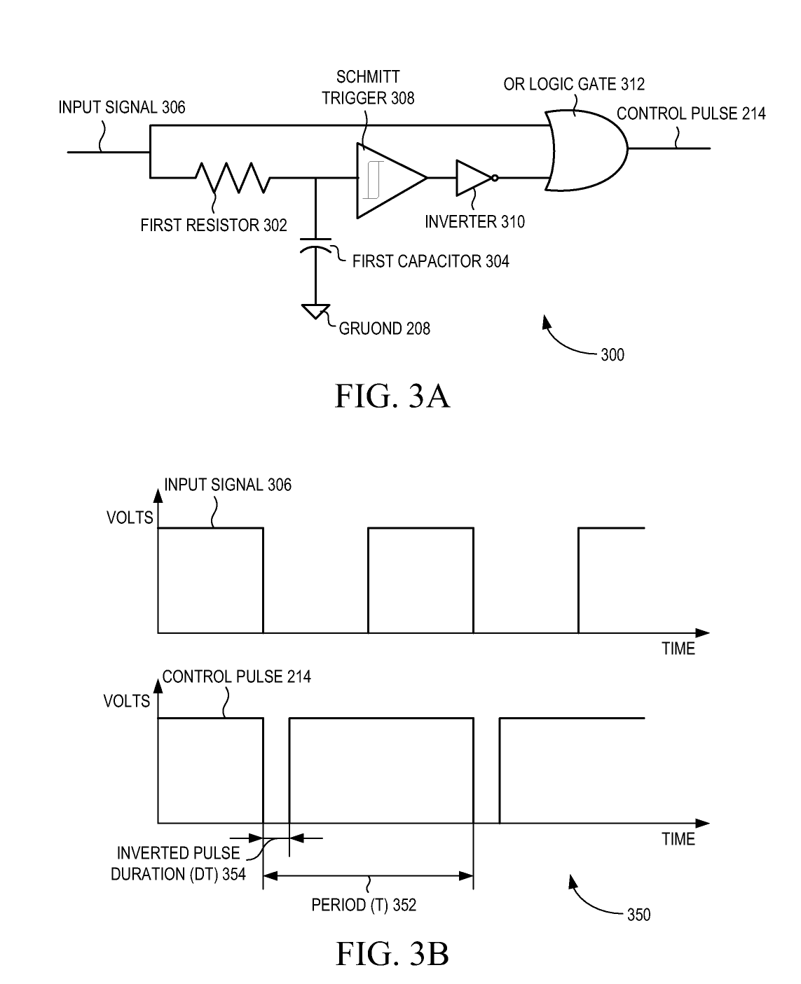

Further, the control pulse is generated by a control pulse generator (e.g., a control pulse generator 300 of FIG. 3A). In one embodiment, the control pulse generator includes a delay element which includes a first resistor (e.g., the first resistor 302 of FIG. 3A) and a capacitor (e.g., the first capacitor 304 of FIG. 3A) and delays an input signal (e.g., an input signal 306 of FIG. 3A). The control pulse generator also includes a Schmitt trigger (e.g., a Schmitt trigger 308 of FIG. 3A) coupled to the delay element for forwarding an output signal of the delay element, an inverter (e.g., an inverter 310 of FIG. 3A) coupled to the Schmitt trigger 308 for inverting the output signal, and an OR logic gate (e.g., an OR logic gate 312 of FIG. 3A) coupled to the inverter and to a node of the input signal for generating the control pulse by processing the output signal and the input signal. In one exemplary implementation, the duty cycle of the PWM controller 114, which turns on and off the switches 104 and 112, is controlled based on the difference between the output voltage 116 and ramped reference voltage 118.

In accordance with the above mentioned embodiments, turning on and turning off of the switches result in the output voltage 116 following the ramped reference voltage 118. The PWM controller 114 compares the output voltage 116 with the ramped reference voltage 118 generated by the soft start circuit 120 and controls duty cycle of the first switch 104 and the second switch 112 such that the output voltage 116 is approximately equal to the ramped reference voltage 118.

In one embodiment, the soft start circuit 120 is implemented by slowly increasing the ramped reference voltage 118. As shown in FIG. 1, the output voltage 116 is connected to the PWM controller 114 through a feedback path. Further, the PWM controller 114 does not allow the output voltage 116 to increase rapidly and causes the output voltage 116 to track the ramped reference voltage 118. It is appreciated that, slow increase of the output voltage 116 is possible only when the inductor current is low. In one exemplary implementation, the inductor current is controlled to avoid the damage to the switches 104 and 112, the inductor 106, and the capacitor 108 associated with the buck converter 100. In one exemplary implementation, the typical value of slope of the ramped reference voltage 118 is usually 0.5V/ms for portable buck converters.

FIG. 2 is a schematic diagram for an exemplary system 200 for generating a ramped reference voltage 212 to soft start a buck converter, according to one embodiment. Particularly, FIG. 2 illustrates the system 200 for generating a ramped reference voltage 212 to soft start a buck converter (e.g., the buck converter 100 of FIG.1). As shown in FIG. 2 the system 200 includes a current source 204 coupled to a positive power supply V_{DD} 202, a capacitor 206 coupled to a ground 208, and a switch 210 coupled to the current source 204 and the capacitor 206 in series. It is appreciated that, the ramped reference voltage 212 is a voltage across the capacitor 206.

In one exemplary implementation, the switch 210 is regulated by a control pulse 214 to direct a flow of a current from the current source 204 for generating a pulsed current 216 forwarded to the capacitor 206. Further as illustrated in FIG. 2, the current source 204 is generated using a resistor 218, and the current is inversely proportional to the resistor 218. In one example embodiment, the switch 210 includes a pass transistor device. In one exemplary implementation, a PMOS transistor is the switch 210. In one exemplary implementation, the capacitor 206 is approximately 10 pico Farad in size.

In operation, the pulsed current 216 is used to charge the capacitor 206, and the switch 210 controls the charging of the capacitor 206. Further, the slope of the ramped reference voltage 212 is controlled based on the turn on and turn off periods of the switch 210. For example, assume that the period of the pulse applied to the switch 210 is T and the duty cycle (i.e., turn on time/period (T)) is D. In this case, the capacitor 206 charges by (I*D*T)/C, where I is the pulsed current 216 and C is the capacitance of the capacitor 206. Therefore, the slope of the ramped reference voltage 212 is given by (I*D)/C.

For example, using the capacitor of 10 pF and charging current of 1 μA, a slope of 0.5 V/ms is achieved by adjusting the duty cycle to (0.5 V/ms)*(10 pF)/1 μA=0.5%. Further, the turn on and turn off periods of the switch 210, are controlled by applying the control pulse 214 to the switch 210, where the control pulse 214 is generated by using the control pulse generator 300, as will be illustrated in FIG. 3A.

FIG. 3A is a schematic diagram for an exemplary control pulse generator 300 for regulating the switch 210 of the system 200 which generates the ramped reference voltage 212 in FIG. 2, according to one embodiment. Particularly, the control pulse generator 300 generates the control pulse 214 that regulates the switch 210 to direct a flow of current from the current source 204 which generates the pulsed current 216 forwarded to the capacitor 206. In one embodiment, the control pulse generator 300 includes a delay element including a first resistor 302 and a first capacitor 304 for delaying an input signal 306.

The control pulse generator 300 also includes a Schmitt trigger 308 (e.g., or a buffer), which is coupled to the delay element and forwards an output signal of the delay element. Furthermore, the control pulse generator 300 includes an inverter 310 coupled to the Schmitt trigger 308 for inverting the output signal of the Schmitt trigger 308. In addition, the control pulse generator 300 includes an OR logic gate 312 coupled to the inverter 310 and to a node of the input signal 306 for generating the control pulse 214 by processing the output signal forwarded by the inverter 310 and the input signal 306.

FIG. 3B is an exemplary view 350 illustrating an exemplary input signal supplied to the control pulse generator 300 and an exemplary control pulse generated by the control pulse generator 300 of FIG. 3A, according to one embodiment. It is appreciated that the exemplary input signal comprises the input signal 306. It is also appreciated that the exemplary control pulse comprises the control pulse 214 of FIG. 2. As illustrated in FIG. 3B, the input signal 306 includes a clock signal from a clock of the buck converter 100 of FIG. 1. Further, the control pulse 214 includes a pulse duration proportional to the delay of the delay network comprised by the resistor 302 and capacitor 304.

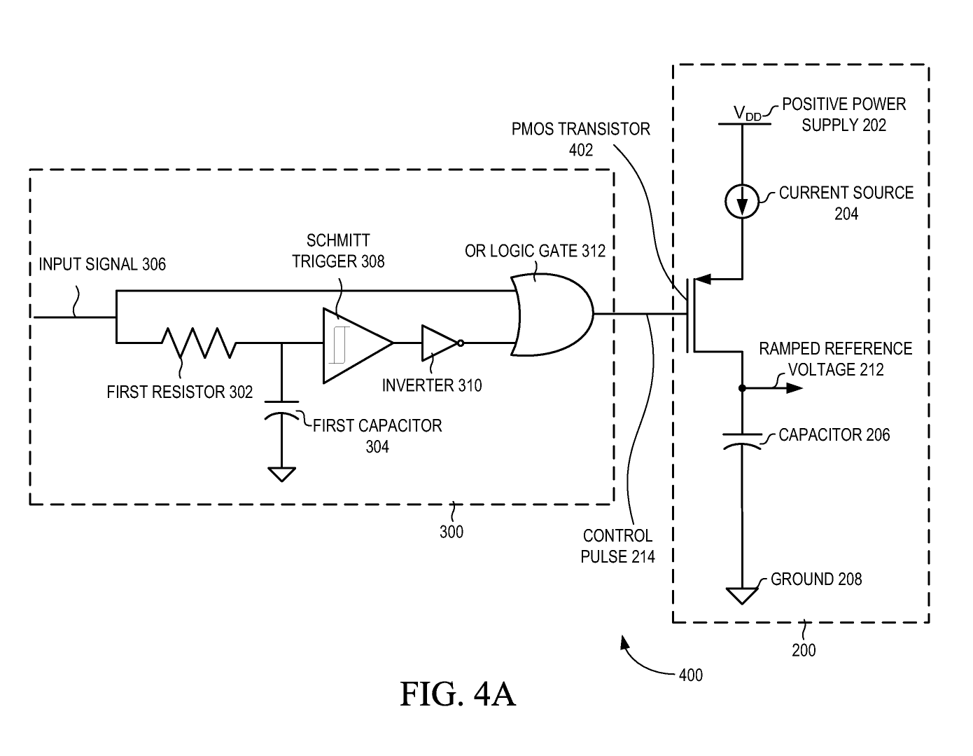

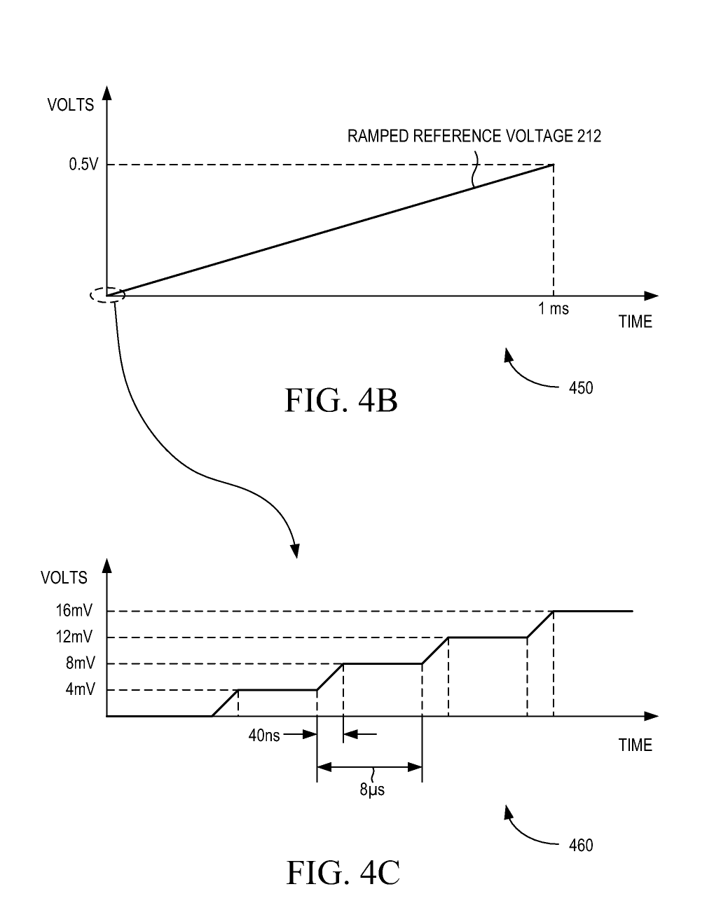

In one example embodiment, if a PMOS transistor is used as the switch 210, then the control pulse 214 shown in FIG. 3A is directly used to control the switch 210. It is appreciated that, an inverted pulse duration (DT) 354 is proportional to the product of first resistor 302 and the first capacitor 304, i.e., DT=K*R₁*C₁, where T is the total period 352, K is a proportionality constant, R₁ is the first resistor 302 and C₁ is the first capacitor 304. The soft start circuit 120 which generates the ramped reference voltage 212 is formed by the combination of the system 200 of FIG. 2 and the control pulse generator 300 of FIG. 3, as will be illustrated in FIG. 4A.

FIG. 4A is a schematic diagram for another exemplary system 400 for generating a ramped reference voltage to soft start a buck converter, according to one embodiment. Particularly, FIG. 4A illustrates the control pulse generator 300 coupled to the system 200 of FIG. 2 to generate the ramped reference voltage 212. As illustrated in FIG. 4A, the system 200 includes the current source 204 coupled to the positive power supply V_{DD} 202, the capacitor 206 coupled to the ground 208, a pass transistor device (e.g., the PMOS transistor 402) coupled to the current source 204 and the capacitor 206 in series.

Furthermore, the control pulse generator 300 which generates a control pulse 214 forwarded to the pass transistor device 402, includes a delay element based on the first resistor 302 and the first capacitor 304. The delay element delays the input signal 306, and the Schmitt trigger 308 coupled to the delay element forwards the output signal of the delay element. The control pulse generator 300 also includes the inverter 310 coupled to the Schmitt trigger 308 which inverts the output signal as well as the OR logic gate coupled to the inverter 310 and to a node of the input signal 306. The OR logic gate generates the control pulse 214 by processing the output signal and the input signal 306.

Furthermore, as illustrated in FIG. 4A, the output node of the control pulse generator 300 is coupled to the gate of the PMOS transistor 402. In one embodiment, the control pulse 214 regulates the flow of a current from the current source 204 to the capacitor 206 via the pass transistor device 402. In one embodiment, the ramped reference voltage 212 forwarded to the buck converter 100 is voltage formed across the capacitor 206. Further, the first capacitor 304 and the capacitor 206 are small in size such that the first capacitor 304 and the capacitor 206 are implemented on-chip with the buck converter 100. In addition the current source is generated using a resistor 218 of FIG. 218. It is appreciated that the current through the current source 204 is inversely proportional to the resistor 218 of FIG. 2.

In one embodiment, the first resistor 302 and the resistor 218 are implemented with a same type of resistors, and the first capacitor 304 and the capacitor 206 are implemented with a same type of capacitors such that the ramped reference voltage 212 is process and temperature independent.

In one embodiment, the slope of the ramped reference voltage 212 is made process independent by selecting the current (I) such that I=V_{constant}/R₂, where R₂ refers to the resistor 218 of FIG. 2, and V_{constant} is a constant dc voltage. Given that R₁ refers to the first resistor 302, C₁ the first capacitor 304, and C the capacitor 206, and R₁ and R₂ are the same type of resistors and C₁ and C are the same type of capacitors, the slope of the ramped reference voltage 212 is given as I*D/C. By substituting the value of D (i.e., KR₁C₁/T) and I (V_{constant}/R₂) in the above equation, the equation becomes V_{constant}*(K*R₁*C₁)/(T*C*R₂). Therefore the slope of the ramped reference voltage 212 is given by

Slope=(R₁*C₁*V_{constant}*K)/(R₂*C*T)

It can be noted that the slope of the ramped reference voltage 212 is a function of ratios of R₁, R₂, C₁, and C. Since the ratios (i.e., R₁/R₂ and C₁/C) are process and temperature independent and the time period T is controlled by a fixed frequency clock (e.g., the clock of the buck converter), the slope of the ramped reference voltage 212 is made process and temperature independent. Further, the ramped reference voltage 212 of the system 400 of FIG. 4A is shown in FIG. 4B and FIG. 4C.

FIG. 4B illustrates an exemplary view 450 of the ramped reference voltage 212, according to one embodiment. Particularly, FIG. 4B illustrates the ramped reference voltage 212 obtained for the system 400 by using the capacitor 206 and the charging current of 10 pico Farad and 1 μA respectively. Further, a clock signal of 8 μs from a clock of the buck converter 100 in FIG. 1 is used to feed the input signal 306. In the example embodiment illustrated in FIG. 4B, the ramped reference voltage 212 reaches 0.5 V in 1 ms.

FIG. 4C illustrates an exploded view 460 of the ramped reference voltage of FIG. 4B, according to one embodiment. Particularly, FIG. 4C is a zoomed view of the ramped reference voltage 212 (e.g., marked in oval shape in FIG. 4B). From FIG. 4B, it can be noted that the capacitor 206 charges by 4 mV in 40 ns and holds the charge till the next pulse comes. Therefore, the capacitor 206 is charged effectively by 4 mV in 8 ps. It will be appreciated that, the slow increase in ramped reference voltage 212 is possible only when the inductor current is low. The above described soft start scheme increases the life of power switches, output capacitor, and inductor since the inductor current is controlled.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated circuitry (ASIC)).

What is claimed is:

1. A system for generating a ramped reference voltage to soft start a buck converter, comprising:
a current source coupled to a positive power supply;
a capacitor coupled to a ground; and
a switch coupled to the current source and the capacitor in series,
wherein the ramped reference voltage is a voltage formed across the capacitor; and
wherein the switch is regulated by a control pulse to direct a flow of a current from the current source for generating a pulsed current forwarded to the capacitor.

2. The system of claim 1, further comprising a control pulse generator for generating the control pulse.

3. The system of claim 2, wherein the control pulse generator comprises:
a delay element comprising a first resistor and a first capacitor for processing an input signal;
a Schmitt trigger coupled to the delay element for forwarding an output signal of the delay element;
an inverter coupled to the Schmitt trigger for inverting the output signal; and
an OR logic gate coupled to the inverter and to a node of the input signal for generating the control pulse by processing the output signal forwarded by the inverter and the input signal.

4. The system of claim 1, wherein the switch comprises a pass transistor device.

5. The system of claim 3, wherein the switch comprises a PMOS transistor.

6. The system of claim 5, wherein the input signal comprises a clock signal from a clock of the buck converter.

7. The system of claim 6, wherein the control pulse comprises a pulse width modulated (PWM) signal of the clock signal.

8. The system of claim 7, wherein the first capacitor and the capacitor are small in size such that the first capacitor and the capacitor are implemented on-chip with the buck converter.

9. The system of claim 8, wherein each of the first capacitor and the capacitor is approximately 10 pico Farad in size.

10. The system of claim 9, wherein the current source comprises a resistor, and the current source is inversely proportional to the resistor.

11. The system of claim 10, wherein the first resistor and the resistor are implemented with a same type of resistors and the first capacitor and the capacitor are implemented with a same type of capacitors such that the ramped reference voltage is process and temperature independent.

12. A system for generating a ramped reference voltage to soft start a buck converter, comprising:
a current source coupled to a positive power supply;
a capacitor coupled to a ground;
a pass transistor device coupled to the current source and the capacitor in series; and
a control pulse generator for generating a control pulse forwarded to the pass transistor device,
wherein the ramped reference voltage forwarded to the buck converter comprises a voltage formed across the capacitor; and
wherein the control pulse regulates a flow of a current from the current source to the capacitor via the pass transistor device for generating the ramped reference voltage.

13. The system of claim 12, wherein the control pulse generator comprises:
a delay element comprising a first resistor and a first capacitor for processing an input signal;
a Schmitt trigger coupled to the delay element for forwarding an output signal of the delay element;
an inverter coupled to the Schmitt trigger for inverting the output signal; and
an OR logic gate coupled to the inverter and to a node of the input signal for generating the control pulse by processing the output signal and the input signal.

14. The system of claim 13, wherein the pass transistor device comprises a PMOS transistor.

15. The system of claim 14, wherein an output node of the control pulse generator is coupled to a gate of the PMOS transistor.

16. The system of claim 15, wherein the input signal comprises a clock signal.

17. The system of claim 16, wherein the control pulse comprises a pulse width modulated (PWM) signal of the clock signal.

18. A buck converter on a system on chip, comprising:
a first switch coupled to a voltage source;
an inductor coupled to the first switch;
a capacitor coupled to the inductor and to a ground in series;
a second switch coupled to the inductor and to the capacitor;
a pulse width modulation (PWM) controller for regulating the first switch and the second switch by comparing an output voltage measured across the capacitor and a ramped reference voltage; and
a soft start circuit for forwarding the ramped reference voltage, comprising:
a current source coupled to a positive power supply;
a first capacitor coupled to the ground; and
a third switch coupled to the current source and the first capacitor in series,
wherein the ramped reference voltage is a voltage formed across the first capacitor; and
wherein the third switch is regulated by a control pulse to direct a flow of a current from the current source for generating a pulsed current forwarded to the first capacitor.

19. The buck converter of claim 18, wherein the control pulse is generated by a control pulse generator, comprising:
a delay element comprising a first resistor and a second capacitor for processing an input signal;
a Schmitt trigger coupled to the delay element for forwarding an output signal of the delay element;
an inverter coupled to the Schmitt trigger for inverting the output signal; and
an OR logic gate coupled to the inverter and to a node of the input signal for generating the control pulse by processing the output signal and the input signal.

20. The buck converter of claim 18, wherein the first switch is turned off and the second switch is turned on if the output voltage is greater than the ramped reference voltage, and wherein the second switch is turned off and the first switch is turned on if the output voltage is less than the ramped reference voltage.
